(19) United States
(12) Patent Application Publication
(10) Pub. No.: US 2004/0057424 A1
(43) Pub. Date: Mar. 25, 2004

(54) Communications system

(76) Inventor: Jani Kokkonen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/416,849

(22) PCT Filed: Nov. 5, 2001
(86) PCT No.: PCT/EP01/12774

(30) Foreign Application Priority Data
Nov. 16, 2000 (GB) 0027985.1

(51) Int. Cl. H04L 12/66; H04L 12/28

(52) U.S. Cl. 370/352; 370/395.5

(57) ABSTRACT

A communication system for transferring data packets between a network device located within a first network and a network device located within a second network. The data packets having a header allowing each packet to be routed independently through each node of the second network using routing information to process the header of each incoming data packer and forward the data packet to the next node. The headers of each of said data packets entering said first network at an ingress node are encapsulated by assigning at least one label to each data packet so that the data packets can be forwarded by each of the intermediate nodes based on said label without having to process the header information.

The field of the invention relates to a communication system where transport level user data packets are encapsulated.

The growth of mobile communications and the Internet have spurred innovation and new technology in these areas, where the requirements of the modern day user are becoming more demanding. The boundaries between the various ‘traditional’ networks are becoming increasingly blurred. Nowadays, there is a significant overlap between applications traditionally in the telecommunications domain, i.e. circuit-switched traffic (voice) and applications traditionally in the data communication domain, i.e. packet-switched traffic (data). For instance, a mobile user forming part of the PLMN (Public Land Mobile Network) can now retrieve data from the Internet.

At present, there is a transition from second generation radio networks to third generation (3G) systems. Second generation mobile included the GSM system that made use of a combination of FDMA (Frequency division Multiple Access) and TDMA (Time Division Multiple Access), i.e. the allocated frequency spectrum is divided into frequency channels where each frequency channel carries eight TDMA channels. However, GSM (Global System for Mobile Communication) remains a circuit-switched technology where a communication channel will be dedicated to a user for the duration of the call. In contrast data communications, for example over the Internet, is performed by transferring data packets through a network where data is of a ‘bursty’ nature. A packet-switched network is preferred for data communications where a channel can be released immediately after packets are transmitted allowing more efficient resource use, for example by statistical multiplexing where many users can share a communications channel.

The two basic approaches to packet-switching are well known:

i) “Connection-oriented” where during an initial phase a ‘virtual circuit’ is first established between two end-users (analogous to a standard voice circuit) and then packet data is transmitted down this pipe. An example is the X.25 network used for public packet data networks.

ii) “Connection-less” also known as datagram switching or a “best-effort network”. An example of this approach is the Internet, which uses a datagram service where at each node (or router) the IP packet header is examined and the packet is routed to another intermediate node that is closer to the recipient. Thus, the packets are routed on a ‘hop-by-hop’ basis.

One of the differences between these two approaches is that the packet structure of the “connection-oriented” approach can use short headers, because the path of the envisaged data stream (virtual circuit) has already been established. In contrast, the data packets for the connection-less approach can arrive at the receiver in any order and each packet is treated as a ‘self-contained’ entity and therefore the header needs to carry full information about the intended recipient.

A limitation on existing 2G mobile systems is the slow data rates that are possible when retrieving data packets. Thus, one of the aims of 3G systems is to increase data transmission rates over the radio interface. In the interim, one of the solutions intended to bridge this gap is GPRS (General Packet Radio Service), which can be used with GSM and improves wireless access to packet data networks.

GPRS is composed of a backbone network that links various GSN's (GPRS Support Nodes). This network is also called the core network, which can be thought of a privately addressed IP network that uses the GTP (GPRS Tunnelling Protocol) to communicate between nodes. As described above, IP networks use a best-effort approach where a relatively large amount of processing is conducted on the IP packet header of each node of the network.

One of the aims of the present invention is to alleviate the processing overhead incurred when using GTP to route packets through the core network.

The present invention provides in one aspect a communication system for transferring data packets between a network device located within a first network and a network device located within a second network, the data packets having a header allowing each packet to be routed independently through each node of the second network using routing information to process the header of each incoming data packet and forward the data packet to the next node; wherein the headers of each of the data packets entering the first network at an ingress node are encapsulated by assigning at least one label to each data packet so that the data packets can be forwarded by each of the intermediate nodes based on the label without having to process the header information.

Preferably, wherein the first network is a UMTS network having a radio access network and a core network such that the network device located within the first network is a mobile station that communicates with the nodes of the UMTS network over the radio access network and wherein the nodes communicate with one another over the core network.

The data packets are transferred within the first and second networks using respective first and second formats which are different such that data packets entering the first network from the second network can be tunnelled through the first network using the first format and wherein the tunnelling information is mapped into at least one of the assigned labels for each data packet at the ingress node to the first network.

The definition of the first network may vary depending on the application. However one example is where the first network a UMTS network and the second network is an external packet data network. Also, an example of the different format used in the respective networks is that the first format may be GTP while the second format may be IP.

The present invention provides in a further aspect a method of transferring data packets in an IP RAN: a base transceiver station for receiving headed data packets from the mobile station and acting as an ingress node for the radio access network by assigning at least one label to each of the data packets; a plurality of intermediate nodes forming the radio access network wherein each of the intermediate nodes is equipped to forward the data packets in dependence on the assigned labels.

The present invention will now be described by way of an example with reference to the accompanying drawings, in which:—

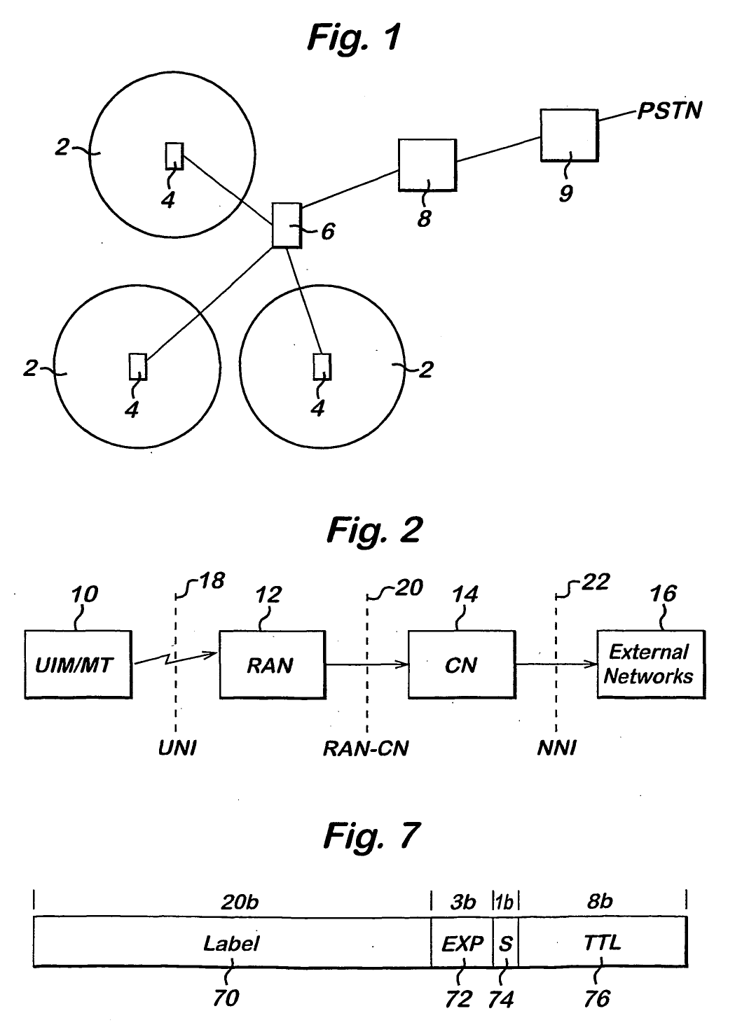

FIG. 1 shows the GSM hierarchy;

FIG. 2 shows the overall system structure of IMT-2000;

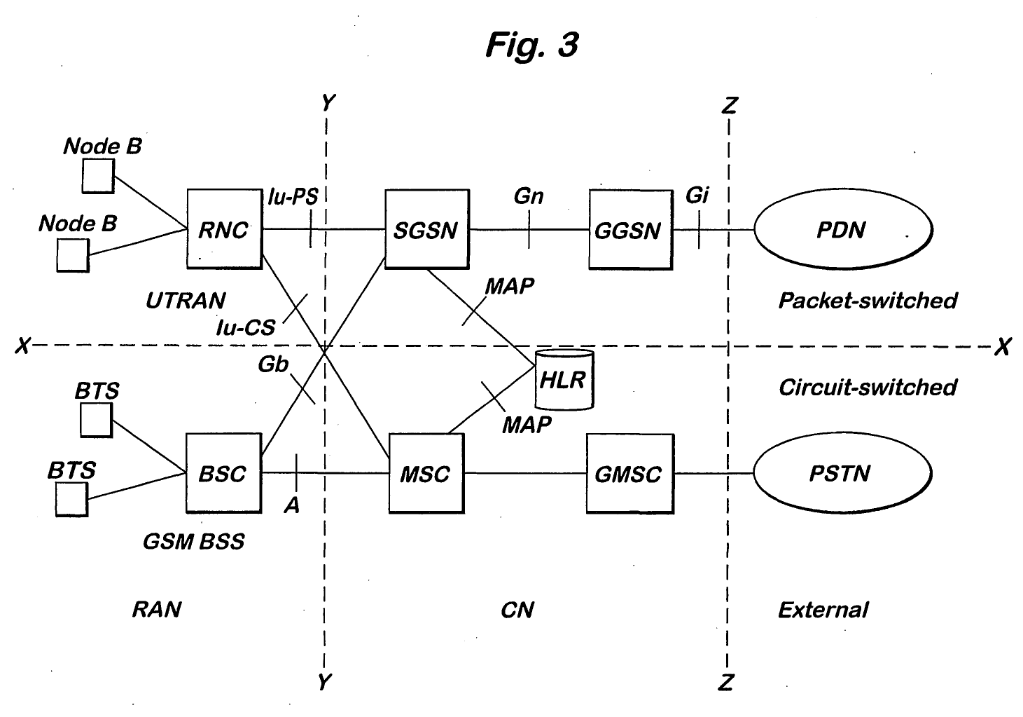

FIG. 3 shows the UMTS R99 architecture;

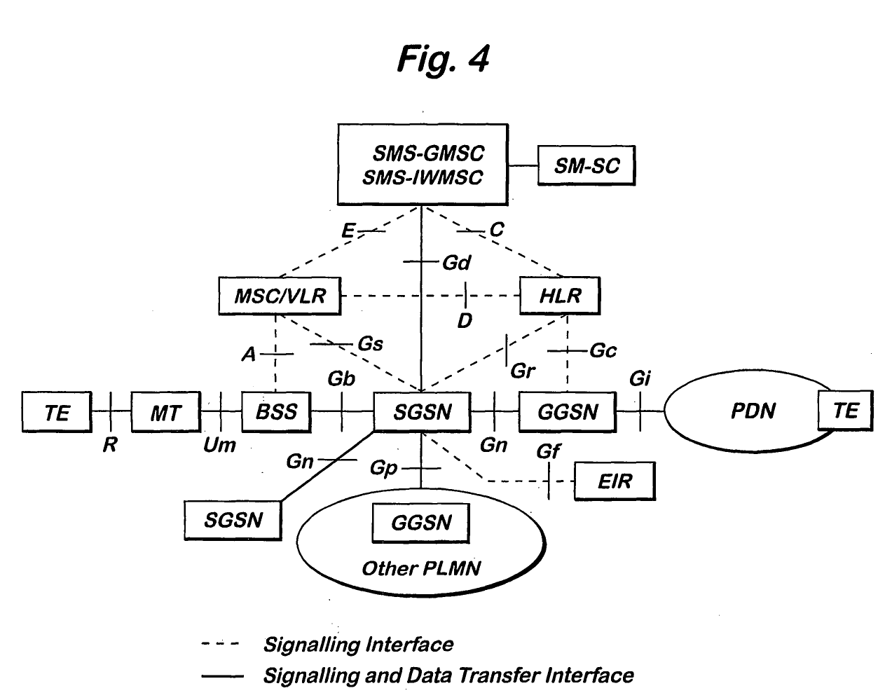

FIG. 4 shows the logical architecture of the GPRS network;

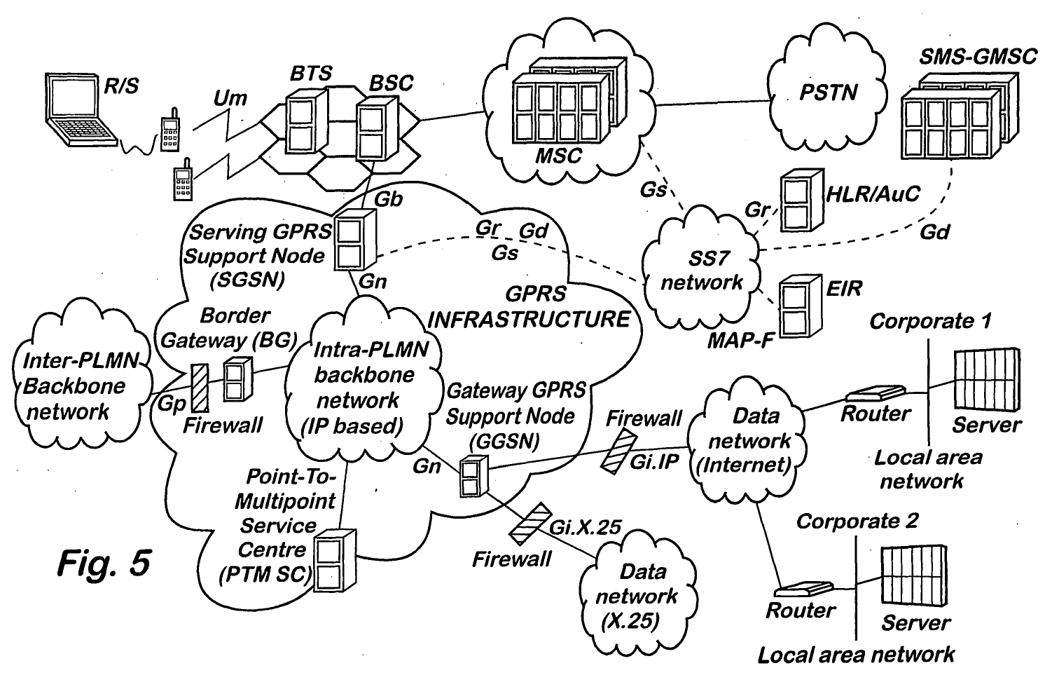

FIG. 5 shows an example of the physical architecture of a GPRS network;

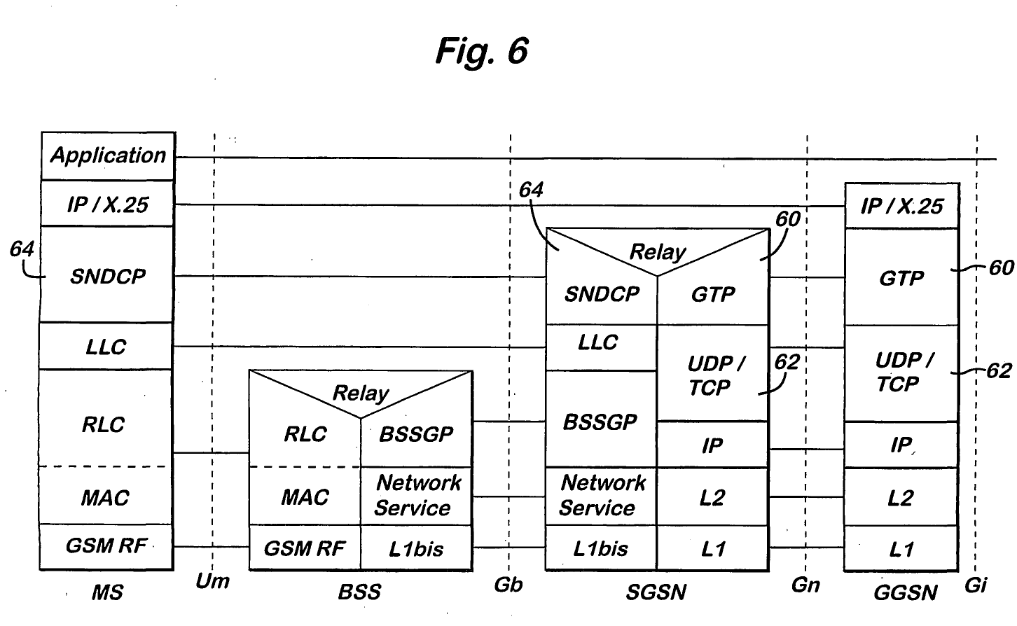

FIG. 6 shows the transmission plane of the GPRS network;

FIG. 7 shows the structure of an MPLS label;

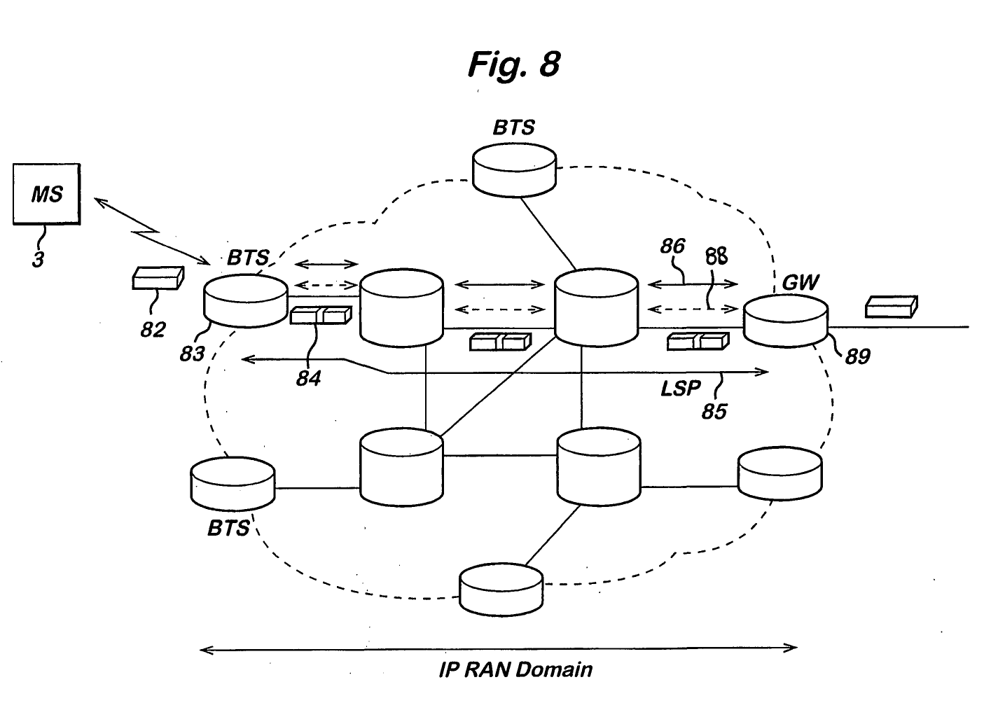

FIG. 8 shows MPLS (Multi Protocol Label Switching) in an IP RAN (Radio Access Network) domain;

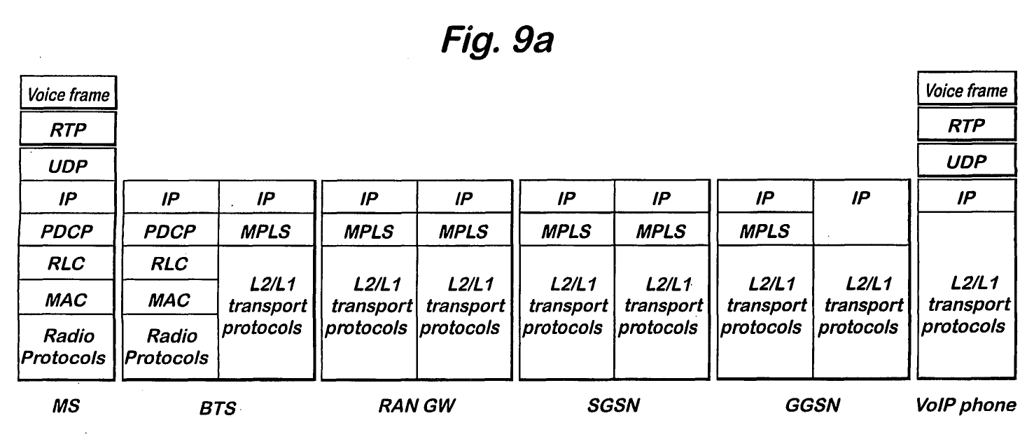

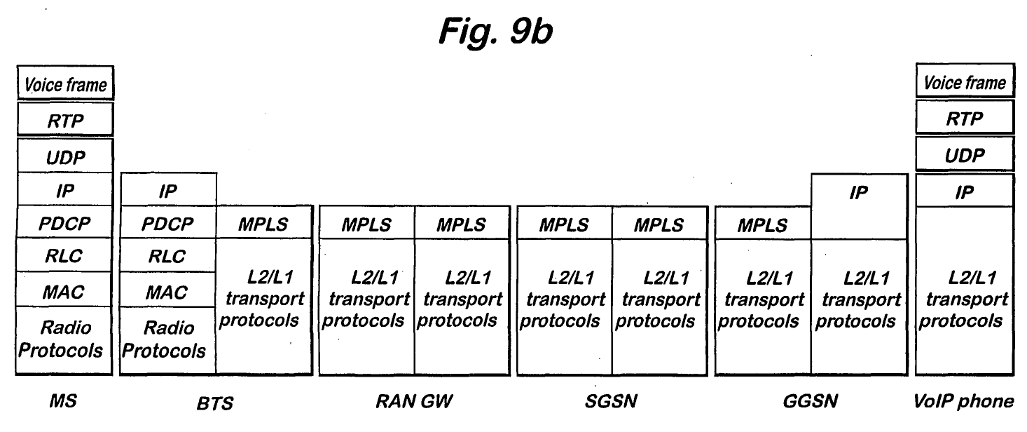

FIGS. 9a and 9b shows the control and transport planes when MPLS is used in IP RAN.

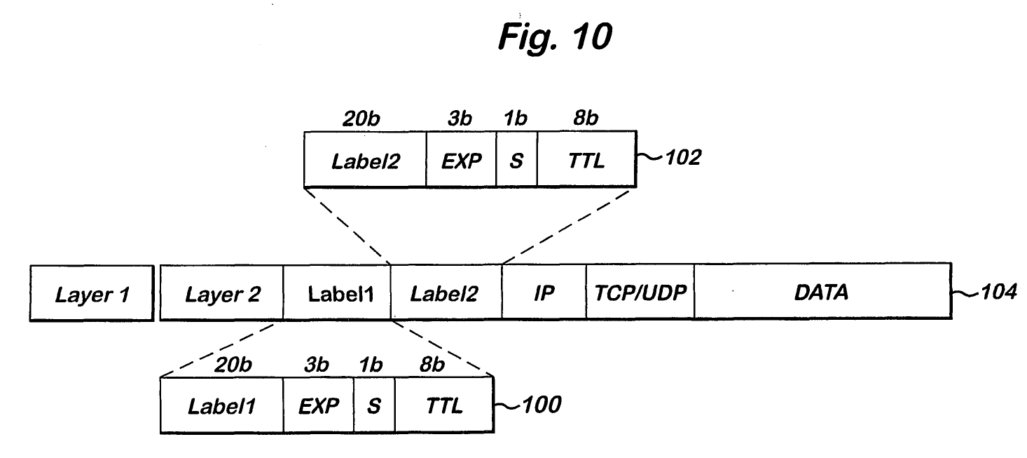

FIG. 10 shows a preferred embodiment 0 of the present invention;

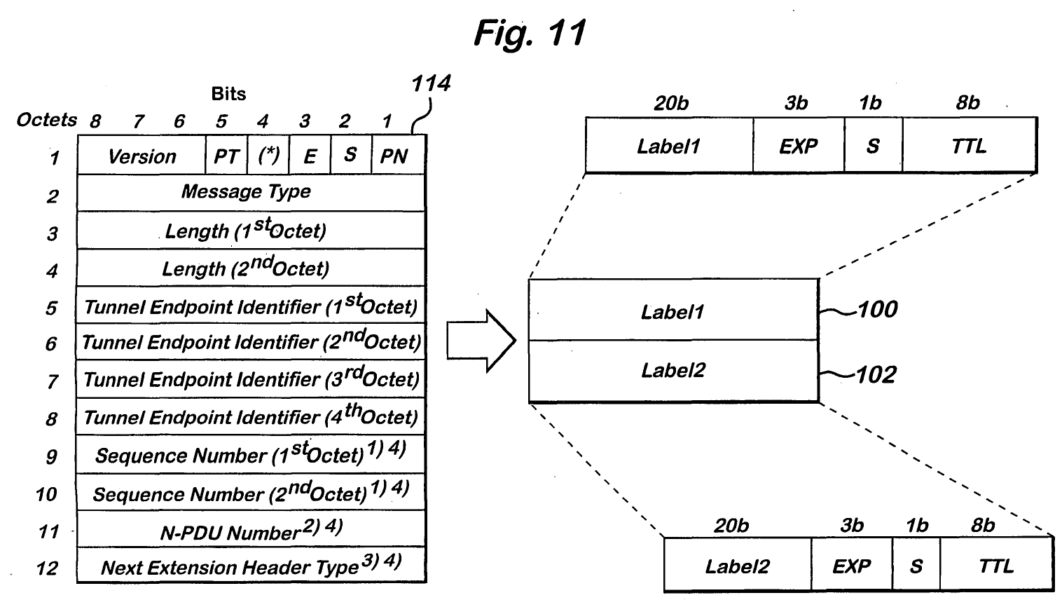

FIG. 11 shows the GTP header information mapping to the two MPLS labels.

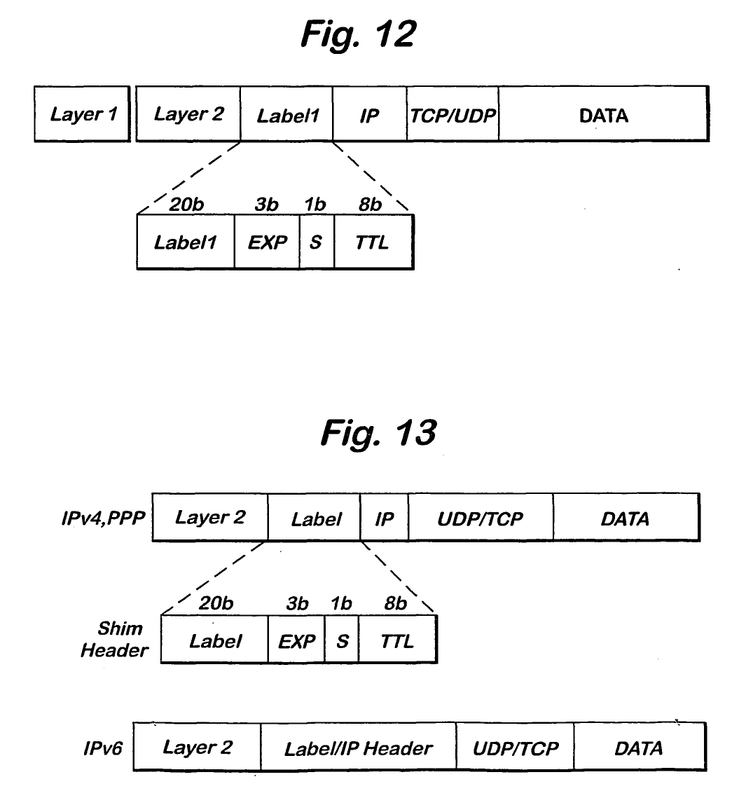

FIG. 12 shows an alternative embodiment of the present invention; and

FIG. 13 shows the present invention being applied to IPv4 and IPv6 data packets.

A list of all the acronyms used in this description is provided in the annex. FIG. 1 shows' a general GSM hierarchy where a MS (Mobile Station) 3 can transmit and receive communications to and from a BTS (Base Transceiver Station) 4, where each BTS 4 has a certain coverage area 2. A group of BTS's 4 is controlled by a BSC (Base Station Controller) 6—and this combination of elements makes up the BSS (Base Station Subsystem). Also a group of BSC's 6 are controlled by an MSC (Mobile Switching Centre) 8. The MSC is also able to interface with other networks, for example the PSTN through a GMSC (Gateway) 9.

UMTS

UMTS (Universal Mobile Telecommunications System) is the European vision for 3G. The IMT-2000 (Internal Mobile Telecommunications) is an attempt by the ITU (International Telecommunication Union) to standardize certain functional elements and interfaces of 3G systems. The terms UMTS and IMT-2000 are often used interchangeably in relation to 3G systems. FIG. 2 shows the overall system structure of IMT-2000. A UIM (User Identity Module) or MT (Mobile Terminal) 10 communicates with the RAN (Radio Access Network) 12 over the UNI (User-Network Interface) 18. The RAN 12 communicates with the CN (Core Network) 14 over the RAN-CN interface 20. At the highest level, the CN 14 communicates with any other external networks 16 over the NNI (Network-Network Interface) 22.

More generally, UMTS is concerned with the RAN 12 and CN 14 elements, where the RAN-CN interface that connects these two elements is known as the ‘Iu interface’. The UTRAN (UMTS Terrestrial Radio Access Network) is composed of a node B and a RNC (Radio Network Controller), which are equivalent to a BTS and a BSC in the GSM hierarchy. The intention of UTRAN is to provide a flexible radio interface that is operable under a variety of conditions such as indoor and/or mobile use. A popular suggestion is that the RAN makes use of a FDD (Frequency Division Duplex) and WCDMA (Wideband—Code Division Multiple Access) implementation. Furthermore, the CN (Core Network) is concerned with the control and routing operations of the backbone network.

FIG. 3 is a representation of the UMTS R99 architecture, which shows the core network as comprising two domains divided by the horizontal dotted line X-X. The domain below line X-X indicates a circuit switched network, whereas the upper domain shows a packet switched network. In practice this might be implemented as a GSM network overlaid with a GPRS network. Furthermore, the portion of FIG. 3 to the left of the vertical dotted line Y-Y indicates the RAN. The portion between the two vertical dotted lines Y-Y and Z-Z is the CN. The portion to the right of vertical dotted line ZZ indicates the external networks, where for the circuit-switched domain this might be a connection to the PSTN and for the packet-switched domain this might be a PDN (Packet Data Network) such as the Internet.

FIG. 3 also shows the various interfaces that have been defined for UMTS. The A-interface exists between the BSC and the MSC for the circuit-switched domain. More importantly, two interfaces are defined for the RAN of the UMTS model, these are the:

Iu-CS interface, which connects the RNC to the circuit-switched domain

IU-PS interface, which connects the RNC to the packet-switched domain.

GPRS

For GPRS, some of the interfaces are shown in FIG. 3, while a more complete representation can be seen in FIG. 4 that shows the logical architecture of the GPRS network. As explained above, UMTS packet services are based on GPRS architecture for wireless access networks. GPRS defines some additional network elements to the conventional GSM network, which are known as GSN's (GPRS support nodes). The dotted lines in FIG. 4 indicate a signalling interface, while the solid lines indicate a signalling and data transfer interface. In particular, there are two types of GSN:

1. SGSN (Serving GPRS Support Node) which is a GSN either connected to another GSN over a Gn interface in the same PLMN (i.e. an intra-PLMN), or connected to a GSN over a Gp interface in a different PLMN (i.e. inter-PLMN). FIG. 5 shows an example of a physical GPRS network including the various interfaces as well as the relationship between an inter-PLMN IP network and an intra-PLMN network.

2. GGSN (Gateway GPRS Support Node) which is a gateway to external networks such as a PDN (Packet Data Network), which may be the Internet or an X.25 network. The GGSN converts data packets coming from the SGSN into the appropriate PDP (Packet Data Protocol) format of the external network, i.e. IP or X.25. Similarly, all packets coming from the other direction are re-addressed to the relevant SGSN.

The GSN's may be interconnected to form the core network with privately addressable space between the GGSN and SGSN (Gn interface) of a given PLMN (Public Land Mobile Network). The GSN's communicate using an IP-based GPRS backbone network where the GSN's encapsulate the external PDN (Packet Data Network) packets and use GTP (GPRS Tunnelling Protocol) to tunnel these packets through the core network. Broadly speaking, tunnelling is the act of transporting protocols foreign to an intermediate network by encapsulating the data packets on entry and decapsulating on exit from the intermediate network, so that the encapsulated foreign protocol appears transparent to the intermediate network.

GTP (GPRS Tunnelling Protocol) is used between GSN nodes in the core network and is defined for both the Gn and Gp interfaces. Furthermore, GTP is defined for both signalling and data transfer procedures. GTP specifies a tunnel and management protocol in the signalling plane. Signalling is used to set up a context as well as create, modify and delete tunnels. In the transmission plane, GTP uses a tunnelling mechanism to carry user data packets. FIG. 6 shows the transmission plane of the GPRS network. It can be seen that below GTP 60, either TCP (Transmission Control Protocol) or UDP (User Datagram Protocol) 62 may be used depending on the PDP type. For an IP network where a less reliable connection is tolerated, UDP is used. In contrast, for the X.25 network, which is a connection-orientated network, TCP is used. The SNDCP (Sub-Network Dependent Convergence Protocol) 64 is used to transfer data packets between the SGSN and the MS.

MPLS

MPLS is a packet forwarding technique standardised by the IETF (Internet Engineering Task Force) that uses labels to make forwarding decisions at the network nodes. More generally, short labels also known as shim headers are assigned to data packets that provide information as to the manner in which they should be forwarded through the network.

In a conventional IP network at the network layer, routing of packets is performed on a hop-by-hop basis where the IP network header of each packet is analysed and forwarded to the next router depending on routing tables. This requires processing of the packet header at each node of the network. In contrast, this processing is only performed once at the entrance node of the MPLS network known as the ingress node. The ingress node examines the label and assigns the packet to a stream or path. MPLS is also useful when a certain QoS (Quality of Service) needs to be established. In MPLS, the possible forwarding options in a network domain are partitioned into FEC's (Forwarding Equivalency Classes). For example, all the packets destined for a given egress node and requiring the same QoS may belong to the same FEC.

Traffic engineering allows one to control the routing path taken through a network. This may be advantageous, for example, in a video or real-time application where it is possible to classify critical and normal traffic on a per-path basis. Broadly speaking, LSP's (Label Switched Paths) may be regarded as ‘virtual pipes’ (i.e. connection-orientated) or independent paths that may be set up in an MPLS network. Thus each LSP will have a series of LSR's (Label Switched Routers) that work together to perform MPLS operations on a packet stream. Therefore, packets entering a path at an ingress node might be encapsulated into a FEC and switched across a network without being touched by the intermediate nodes at the IP network level.

In MPLS, traffic aggregation is concerned with binding a single label having a specific-FEC (Forwarding Equivalence Class) to a union of flows with the same FEC, where a flow has the same MPLS label, IP and TCP. It is possible to take advantage of different label granularities, the coarsest being where a set of FEC's is aggregated into a single FEC and the finest being where no aggregation takes place. Traffic aggregation reduces—the number of labels needed to handle a particular set of packets, which also reduces the LDP (Label Distribution Protocol) control traffic. Broadly speaking, traffic aggregation may be done in two ways, i.e. by label merging and by label stacks.

Each of the intermediate nodes of an MPLS network uses the label of the incoming packet to determine its next hop and also performs “label swapping” by replacing the incoming label with a new outgoing label that identifies the respective FEC for the downstream node. The label swapping maps corresponding to the FEC are established using standardised protocols such as RSVP (Resource Reservation Protocol) or CR-LDP (Constraint-based Routing Label Distribution Protocol). This type of label-based forwarding technique reduces the processing overhead required for routing at the intermediate nodes, thereby improving packet forwarding performance and scalability. Furthermore, the label swapping process used by MPLS creates multipoint-to-point packet forwarding trees in contrast to a routing mesh in a conventional network based on a similar paradigm (i.e. ATM).

FIG. 7 shows the structure of a single label. The fields are explained below:

Label 70: The actual assigned label value (20 bits).

EXP 72: The experimental bits used to identify a required QoS (3 bits).

S 74: The stack bit is set if the particular label is at the bottom of the stack (1 bit).

TTL 76: Time to Live Is an 8-bit field used in IP to specify how many more hops a packet can travel before being discarded or retumed, i.e. the maximum time the datagram is allowed to remain in the network. This field may be used differently for the present invention as described later.

For each data packet in the MPLS environment, a label may be assigned after the data link layer (i.e. layer 2) header but before any network layer (i.e. layer 3) header. Each user packet can carry a plurality of labels where a LIFO (Last In First Out) label stack may exist. At an intermediate node, the forwarding decision is based on the label at the top of the stack for each packet. Apart from the ‘swapping’ operation, each node (i.e. router) in an LSP is also normally able to perform push and pop operations for adding and removing labels respectively from the top of the stack. The swap operation simply replaces the label at the top of the stack with a new label (i.e. corresponding to the FEC of the downstream node).

GTP includes both the GTP signalling (GTP-C) and data transfer (GTP-U) procedures. In UMTS, user data packets are transferred using the GTP-U protocol that supports encapsulation of user packets (for example IP, PPP or X.25 packets) and supports optional re-ordering of packets (for non IP-based services). The GTP-C protocol handles all signalling relating to GTP management for the Gp and Gn interfaces, while for the Iu interface this is done by the RANAP (Radio Access Network Application Part) protocol.

IP RAN

There is a drive towards an all IP-based transport network where the RAN (Radio Access Network) is based on IP as well as the core network.

FIG. 8 shows a physical example of applying MPLS to an IP RAN domain. A MS 3 sends an unlabeled packet to a relevant BTS 83. This BTS 83 may be regarded as the ingress node of the IP RAN domain, which supports MPLS and therefore is able to assign labels to the incoming user packets. The arrow marked 85 shows the LSP that is set up through the network to reach the RANGW (Gateway) 89. The gateway would typically connect to a SGSN of a core network (see FIG. 3). For each hop of the LSP, two arrows 86,88 can be seen. Firstly, one set of arrows 86 indicate that normal routing protocols, for example OSPF (Open Shortest Path First), are used to distribute ‘routing table updates’ to reflect network topology changes. This signalling is needed so that every node of the network has an updated picture of the network topology. The other set of arrows 88 indicates that this network picture is needed to distribute ‘label distribution messages’, for example using RSVP, LDP or BGP (Border Gateway Protocol), between neighbouring LSR's (Label Switching Routers). Therefore, one set of arrows 86 indicate routing table updates, while the other set of arrows 88 indicate label distribution messages.

FIGS. 9a and 9b shows the protocol stacks for the respective control and transport planes when MPLS is used: in IP RAN.

FIG. 10 shows the preferred embodiment of the present invention where two MPLS labels are added to a user level IP packet. In known systems, user IP packets 104 are encapsulated by a GTP-U header when entering a GPRS network, instead the present invention replaces the GTP-U header by two MPLS labels 100, 102. FIG. 11 shows the GTP header information 114 mapping to the two MPLS labels. In the preferred embodiment of the present invention, label1 100 is at the top of the label stack and identifies the LSP to be used between the BTS and the RAN GW. Label2102 is the lower label and identifies the MS.

An MPLS label can be assigned to a user level IP packet after a MDC (Micro Diversity Combining) procedure performed at the ingress node. In the R99 UMTS network, the MDC happens in the RNC (Radio Network Controller) and therefore this concept is applicable to the uplink direction from the RNC onwards, i.e. in the Gp and Gn interfaces. On the other hand, if an IP RAN exists, then the MDC function may be pushed to the BTS (or Node B) and therefore the present invention is applicable to the whole UMTS network, which includes both the RAN and CN networks.

The present invention will now be described as it operates over the Iu-Ps interface where this interface is terminated at a BTS in the case of an IP RAN.

In a normal PDP context set-up procedure, in response to a context request message, the SGSN returns the IP address of the SGSN interface and the TEI (Tunnel Endpoint Identifier) in a RANAP (Radio Access Network Application Part) message back to the RNC. For the present invention, the SGSN also returns the IP address of the relevant SGSN interface, but now the MPLS label2 is returned rather then the TEI. The RNC interprets these parameters in the manner described below.

For the SGSN IP address, the SGSN IP address interpretation depends on which MPLS path creation technique is used, i.e. ‘topology-driven’ or ‘request driven’. For topology driven path creation, labels are assigned according to existing routing protocols such as OSPF (Open Shortest Path First). So, the RNC obtains label1 from the NHFLE (Next Hop Label Forwarding Entry) database, based on the SGSN IP address. To support real-time services, a network operator could pre-allocate resources between a RNC and a SGSN so that an adequate QoS could be guaranteed. For request driven path creation, the RNC may use either conventional RSVP (Resource Reservation) or LDP (Label Distribution Protocol) to obtain label1 for the SGSN IP address. Also, RSVP and LDP can allocate resources for the LSP in order to support real time services.

For the MPLS label2, this label is assigned to the user packet to identify the MS inside the top level LSP-tunnel. In this case, the TTL field of the label is not used as a normal hop counter, but rather as a sequence counter ( ) or alternatively to identify the N-PDU (Network Protocol Data Unit) mapped from the GTP header as shown in FIG. 11. Furthermore, because Label2 identifies an MS, it can also be used for charging purposes.

Sequence numbering is used for re-ordering of the packets at the end node. For the example shown in FIG. 9, the end node might be a VoIP (Voice over IP) phone. Such an application (i.e. voice) requires in-order delivery of the data packets, otherwise the voice samples would be reassembled in the wrong order. Another use for a sequence counter is for charging purposes. A network node is able to determine if some data packets are missing, because each packet has a unique serial number. So if a node has received packets: 1, 2, 4 and 5, it can easily determine that packet 3 is missing and that packet should not be charged.

The purpose of each field of Label1 and Label2 is now provided.

| | |
|---|---|
| Label1 | |
| Label: | Identifies an aggregating LSP ( ), i.e. the path from the BTS to |
| | the RAN GW. |
| EXP: | Identifies QoS class, i.e. a Diffserv code point. |
| S: | Set to 1, i.e. indicates the next label in the stack. |
| TTL: | Used to prevent looping, i.e. normal MPLS operation. |
| Label2 | |
| Label: | Identifies the relevant MS. |
| EXP: | Identifies QoS class, i.e. a Diffserv code point that must match |
| | the code point selected for Label1. |
| S: | Set to 0, i.e. indicates no other labels in the stack. |
| TTL: | Used as a sequence number if needed ( ) or to identify the |
| | N-PDU in the GTP header. |

FIG. 12 shows an alternative embodiment of the present invention where only one MPLS label (shim header) is used, if any information that is normally carried in label2 is not needed, i.e. PDU identification or the sequence counter. So the field encoding for label 1 now looks like this:

| | |
|---|---|
| Label1 | |
| Label: | Identifies an aggregating LSP, which in the IP RAN example is |
| | the path from the BTS to the RAN GW. |
| EXP: | Identifies QoS class, i.e. a Diffserv code point. |
| S: | Set to 0, i.e. indicates no other labels in the stack. |
| TTL: | Used to prevent looping, i.e. normal MPLS operation. |

Therefore, the only difference to the preferred embodiment is that the S field is set to 0, because there is no additional label in the stack. Now the user identification is based on the user IP address 122, rather than label2.

FIG. 13 shows that for conventional IP (i.e. IPv4) the MPLS label is marked in front of the IP header, whereas if the latest version of IP (i.e. IPv6) is used and sequence numbering is not needed, then the MPLS label can be marked inside the IPv6 header (i.e. layer 3). However, IPv6 also allows the MPLS label to be marked in front of the IP header as previously described.

Therefore, the present invention proposes a technique of replacing GTP-U encapsulation by hierarchical LSP's. More generally a user level IP packet is encapsulated in two MPLS labels. The invention alleviates the overhead caused by GTP and the additional transport level IP header. The invention allows MPLS traffic engineering and QoS tools to ensure ‘hard’ QoS services. Hard QoS can be achieved by using RSVP or LDP signalling in the tunnel set-up. In addition, in some narrow bandwidth links, the packet overhead can be further decreased when the user level IP/UDP/RTP header is compressed.

ANNEX: List of Acronyms Used

ATM—Asynchronous Transfer Mode

AuC—Authentication Center

BG—Border Gateway

BSSGP—Base Station System GPRS Protocol

BSC—Base Station Controller

BTS—Base Transceiver Station

CN—Core Network

CR—Constraint-based Routing

EIR—Equipment Information Register

FDMA—Frequency Division Multiple Access

FEC—Forwarding Equivalency Classes

GGSN—Gateway GPRS Support Node

GMSC—Gateway Mobile Switching Center

GPRS—General Packet Radio Service

GSM—Global System for Mobile Communication

GSN—GPRS Support Node

GTP—GPRS Tunnelling Protocol

GW—Gateway

IETF—Internet Engineering Task Force

IP—Internet Protocol

HLR—Home Location Register

LDP—Label Distribution Protocol

LSP—Label Switched Path

MAC—Media Access Control

MDC—Micro Diversity Combining

MPLS—Multiprotocol Label Switching

MS/MT—Mobile station or terminal

MSC—Mobile Switching Center

NHLFE—Next Hop Label Forwarding Entry

N-PDU—Network Protocol Data Unit

NSS—Network Subsystem

OSPF—Open Shortest Path First

PDN—Public Data Network

PDCP—Packet Data Convergence Protocol

PDP—Packet Data Protocol

PLMN—Public Land Mobile Network

PSTN—Public Switched Telecommunications Network

RANAP—Radio Access Network Application Part

RLC—Radio Link Control

RNC—Radio Network Controller

RSVP—Resource Reservation Protocol

RTP—Real Time Protocol

SGSN—Serving GPRS Support Node

SN DCP—SubNetwork Dependent Convergence Protocol

TCP—Transmission Control Protocol

TDMA—Time Division Multiple Access

TEI—Tunnel Endpoint Identifier

TTL—Time To Live

UDP—User Datagram Protocol

UIM—User Identity Module (UMTS)

UMTS—Universal Mobile Telecommunications System

UTRAN—UMTS Terrestrial Radio Access Network

VLR—Visitor Location Register

1. A communication system for transferring data packets between a network device located within a first network and a network device located within a second network, said data packets having a header allowing each packet to be routed independently through each node of the second network using routing information to process the header of each incoming data packet and forward the data packet to the next node; wherein the headers of each of said data packets entering said first network at an ingress node are encapsulated by assigning at least one label to each data packet so that the data packets can be forwarded by each of the intermediate nodes based on said label without having to process the header information.

2. A system according to claim 1, wherein said first network is a UMTS network having a radio access network and a core network such that said network device located within said first network is a mobile station that communicates with the nodes of said UMTS network over the radio access network and wherein said nodes communicate with one another over the core network.

3. A system according to claim 1, wherein the data packets are transferred within the first and second networks using respective first and second formats which are different such that data packets entering said first network from said second network can be tunnelled through said first network using the first format and wherein the tunnelling information is mapped into at least one of said assigned labels for each data packet at the ingress node to said first network.

4. A system according to claim 1 or 3, wherein said first network is a UMTS network and said second network is an external packet data network.

5. A system according to claim 3 or 4, wherein said first format is GTP and said second format is IP.

6. A system according to claim 5, wherein the IP version to be used can either be IPv4 or IPv6 such that if IPv6 is used and the data packets do not have to be numbered in sequence then only one label needs to be assigned for each data packet at the ingress node.

7. A system according to claim 1, wherein said network device is a mobile station and said second network is an IP-based radio interface to which the mobile station is located to communicate with a BTS forming the ingress node of the first network such that said ingress node assigns two labels to each of the headed data packets received from the mobile station, wherein the first label indicates a path whereby the data packets are to be switched through the first network and the second label indicates the mobile station.

8. A system according to claim 2, wherein said radio access network is UTRAN and said core network is GPRS.

9. A system according to any preceding claim, wherein the labels that are assigned to each data packet each have a fixed length.

10. A system according to any preceding claim wherein each of said assigned labels comprises:
a label field indicating the actual assigned label value used to forward said data packet;
an experimental field used to identify a required class of service;
a stack field to indicate whether there is another label that has been assigned to the data packet;
a time to live field where if only one label is assigned to a data packet then this field operates as a normal hop counter, while if two labels are assigned then within the second label this field operates as a sequence counter or alternatively identifies the N-PDU if mapped from a GTP header.

11. A method of transferring data packets in an IP RAN:
a base transceiver station for receiving headed data packets from said mobile station and acting as an ingress node for said radio access network by assigning at least one label to each of said data packets;
a plurality of intermediate nodes forming said radio access network wherein each of said intermediate nodes is equipped to forward the data packets in dependence on the assigned labels.

12. A method according to claim 11, wherein two labels are assigned to each data packet to form a label stack such that the first label indicates a path whereby the data packets are to be switched through the radio access network and the second label indicates the mobile station.

13. A method according to claim 12, wherein said path is determined at said ingress node by aggregating data packets having similar characteristics such as the same label, destination and transport protocol.

14. A method according to any of claims 11 to 13, wherein said IP RAN network forms part of a UMTS network that is able to connect to external packet data networks.
